(19) United States
(12) Patent Application Publication
(10) Pub. No.: US 2013/0236214 A1
(43) Pub. Date: Sep. 12, 2013

(54) ELECTRO-CONDUCTIVE MEMBER, PROCESS CARTRIDGE, AND ELECTROPHOTOGRAPHIC APPARATUS

(71) Applicant: CANON KABUSHIKI KAISHA, Tokyo (JP)

(72) Inventors: Satoshi Koide, Otsu-shi (JP); Hidekazu Matsuda, Susono-shi (JP); Noboru Miyagawa, Suntou-gun (JP)

(73) Assignee: CANON KABUSHIKI KAISHA, Tokyo (JP)

(21) Appl. No.: 13/869,390

(22) Filed: Apr. 24, 2013

Related U.S. Application Data
(63) Continuation of application No. PCT/JP2012/007702, filed on Nov. 30, 2012.

(30) Foreign Application Priority Data
Dec. 6, 2011 (JP) 2011-267222

(51) Int. Cl. G03G 15/02

(52) U.S. Cl. CPC G03G 15/0233
USPC 399/176

(57) ABSTRACT

Provided is an electro-conductive member in which a C set hardly occurs. The electro-conductive member is an electro-conductive member including an electro-conductive substrate and a porous rubber elastic layer, in which the porous rubber elastic layer includes closed cells including particles, and the particles are not fixed to inner walls of the closed cells.

### CROSS-REFERENCE TO RELATED APPLICATIONS

This application is a continuation of International Application No. PCT/JP2012/007702, filed Nov. 30, 2012, which claims the benefit of Japanese Patent Application No. 2011-267222, filed Dec. 6, 2011.

### BACKGROUND OF THE INVENTION

1. Field of the Invention

The present invention relates to an electro-conductive member, and a process cartridge and an electrophotographic image-forming apparatus (hereinafter referred to as “electrophotographic apparatus”) which use the electro-conductive member.

2. Description of the Related Art

A roller-shaped electro-conductive member (hereinafter sometimes referred to as “conductive roller”) to be used in a charging roller or the like in an electrophotographic apparatus is provided with a flexible layer so that an appropriate nip width is obtained between the electro-conductive member and an abutment member such as an electrophotographic photosensitive member. An example of such flexible layer is a porous rubber layer containing cells. In this case, the cells in the rubber layer are formed by, for example, addition of a foaming agent or hollow particles.

Meanwhile, in the case where a conductive roller provided with such rubber layer is left to stand still in abutment with an abutment member over a long period of time, strain which is not recovered easily, that is, a permanent compression set or a compression set (hereinafter sometimes referred to as “C set”) may occur in the abutment portion. In particular, in a high-temperature and high-humidity environment, an amount of the C set is liable to increase.

In the case where the electrophotographic photosensitive member is charged by using, as the charging roller, a charging roller in which the C set has occurred, discharge generated in a gap between a surface of the conductive roller and a surface of the electrophotographic photosensitive member becomes unstable when a portion in which the C set had occurred (hereinafter referred to as “C set portion”) passes a discharge region. That is, a difference in charging ability occurs between the C set portion of the electro-conductive member and a portion in which the C set has not occurred. As a result, an electrophotographic image having streak-like unevenness in image density (hereinafter referred to as “C set image”) may be formed in a site corresponding to the C set portion of the electro-conductive member.

As a charging member capable of alleviating the C set causing the above-mentioned phenomenon, Japanese Patent Application Laid-Open No. 2006-154441 discloses a charging member which is formed of a conductive foam and has average cell diameters varying depending upon the sites.

### SUMMARY OF THE INVENTION

The inventors of the present invention studied the charging member according to Japanese Patent Application Laid-Open No. 2006-154441 and confirmed a certain effect of suppressing the C set. However, in recent years, the inventors of the present invention recognized that it is necessary to develop a charging member in which the C set hardly occurs additionally, in order to satisfy the requirements of higher process speed, higher image quality, and higher durability in an electrophotographic apparatus.

The present invention is directed to providing an electro-conductive member in which the C set hardly occurs. The present invention is also directed to providing a process cartridge and an electrophotographic apparatus capable of forming a high-quality electrophotographic image stably.

According to one aspect of the present invention, there is provided an electro-conductive member, including an electro-conductive substrate; and an elastic layer, in which: the elastic layer includes a closed cell including a particle; and the particle is not fixed to an inner wall of the closed cell.

According to another aspect of the present invention, there is also provided a process cartridge, including the above-mentioned electro-conductive member; and a body to be charged, which is integrated with the electro-conductive member, the process cartridge being attachable to and detachable from a main body of an electrophotographic apparatus. According to the present invention, there is also provided an electrophotographic apparatus, including the above-mentioned electro-conductive member; and a body to be charged.

According to the present invention, the electro-conductive member in which the occurrence of the C set is suppressed can be obtained. Further, according to the present invention, the process cartridge and electrophotographic apparatus capable of stably forming a high-quality electrophotographic image can be obtained.

Further features of the present invention will become apparent from the following description of exemplary embodiments with reference to the attached drawings.

### BRIEF DESCRIPTION OF THE DRAWINGS

FIG. 1A is a cross-sectional view of a roller-shaped electro-conductive member according to an embodiment of the present invention.

FIG. 1B is a cross-sectional view of the roller-shaped electro-conductive member according to another embodiment of the present invention.

FIG. 2 is a cross-sectional view of an elastic layer in the present invention.

FIG. 3A is a schematic view illustrating an embodiment of a closed cell including a particle according to the present invention.

FIG. 3B is a schematic view illustrating an embodiment of a closed cell including a particle and having a shell according to the present invention.

FIG. 4A is a schematic cross-sectional view in an axial direction illustrating a measurement portion of a thickness of a conductive resin layer of a conductive roller in the present invention.

FIG. 4B is a schematic cross-sectional view in a direction perpendicular to an axial direction illustrating a measurement portion of a thickness of the conductive resin layer of the conductive roller in the present invention.

FIG. 5 is an explanatory view of a method of measuring an electrical resistance of the conductive roller.

FIG. 6 is a schematic view of an electrophotographic apparatus according to the present invention.

FIG. 7 is a schematic view of a process cartridge according to the present invention.

FIG. 8 is a schematic view of an extruder provided with a crosshead.

FIG. 9 is an explanatory view of a die used for producing a conductive roller according to the present invention.

FIG. 10 is a schematic view illustrating an abutment state between a conductive roller and an electrophotographic photosensitive member.

### DESCRIPTION OF THE EMBODIMENTS

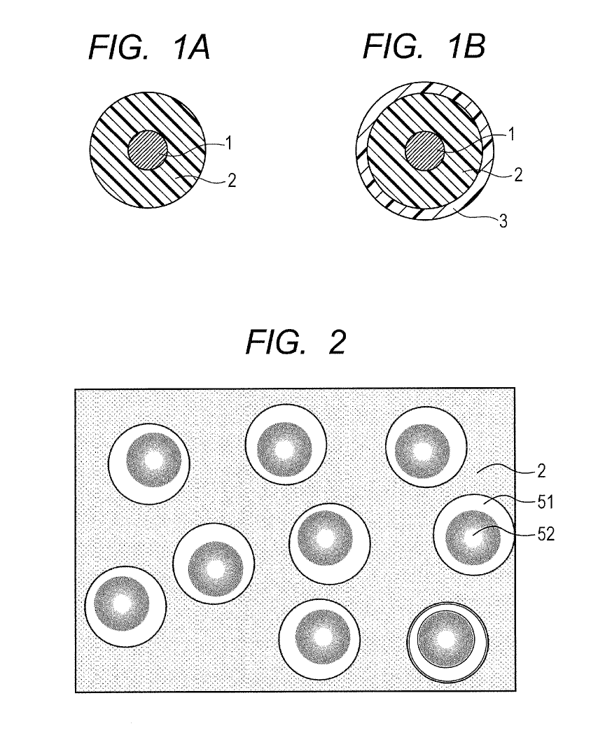

A roller-shaped electro-conductive member (hereinafter referred to as “conductive roller”) according to the present invention includes an electro-conductive substrate 1 and a porous rubber elastic layer (hereinafter sometimes simply referred to as “elastic layer”) 2 covering a circumferential surface of the electro-conductive substrate 1, as FIG. 1A illustrates a cross-section thereof. Then, as illustrated in FIG. 2, the elastic layer 2 includes closed cells 51 including particles 52, and the particles are not fixed to inner walls of the closed cells. That is, the particles are included in the closed cells so as be movable independently from the elastic layer. Such particles play a role in regulating compression deformation of the closed cells. It is to be noted that, as illustrated in FIG. 1B, the conductive roller according to the present invention may have a conductive resin layer 3 on the surface of the elastic layer 2.

The conductive roller according to the present invention is used in abutment with an electrophotographic photosensitive member, for example, and is used as members for various applications of an electrophotographic apparatus, such as a charging roller, a developing roller, and a transfer roller.

Although an example in which a charging roller is used as the conductive roller is hereinafter described, similar effects can be expected as long as the conductive roller is an electrophotographic conductive roller to be used for providing charge, and the conductive roller is not limited to the charging roller. As a use example thereof, the charging roller is installed so as to be brought into abutment with an electrophotographic photosensitive member and to be connected to a power supply to apply a bias to a shaft of the charging roller, thereby charging the electrophotographic photosensitive member to a desired potential.

When the charging roller rotates in an image-forming process, the elastic layer undergoes compression deformation in an abutment portion with respect to the electrophotographic photosensitive member. This can ensure an appropriate nip width between the charging roller and the electrophotographic photosensitive member, stabilize rotation, and charge the electrophotographic photosensitive member uniformly. Further, the elastic layer is brought into abutment with the electrophotographic photosensitive member even during a period of time excluding the image-forming process, for example, when left to stand for a long period of time, and hence the elastic layer undergoes compression deformation. In the image-forming process, the charging roller rotates, and hence a particular portion of the elastic layer undergoes compression deformation for a short period of time. On the other hand, when left to stand for a long period of time, the elastic layer is exposed to compression deformation for a long period of time in its abutment portion with the electrophotographic member. The elastic layer has viscoelasticity, and hence the elastic layer shows a larger compression deformation amount when left to stand than during the image-forming process in which the charging roller is rotating.

The charging roller according to the present invention includes an electro-conductive substrate and an elastic layer. Then, the elastic layer includes closed cells including particles, and the particles are not fixed to inner walls of the closed cells. That is, each of the closed cells has a bell-like structure, and the particles are included in the closed cells so as to be movable independently from the elastic layer.

By configuring the elastic layer as described above, when a compression deformation amount is small as in the image-forming process, a compression deformation amount required for ensuring a nip width can be maintained. On the other hand, in the case where the elastic layer is compressed by being left to stand over a long period of time, the particles present in the cells suppress deformation of the cells due to the compression, and the occurrence of the C set in the elastic layer can be suppressed.

Accordingly, it is considered that, by virtue of the expression of both of an effect of suppressing deformation in the porous elastic layer when left to stand for a long period of time and an effect of ensuring a nip width to stabilize rotation, the occurrence of a set image can be suppressed.

(Elastic Layer)

FIG. 2 is a cross-sectional view of the elastic layer 2. The elastic layer 2 includes the closed cells 51, and each of the closed cells 51 has a so-called bell-like structure in which the particles 52 movable independently from the elastic layer 2 are included in the closed cells 51.

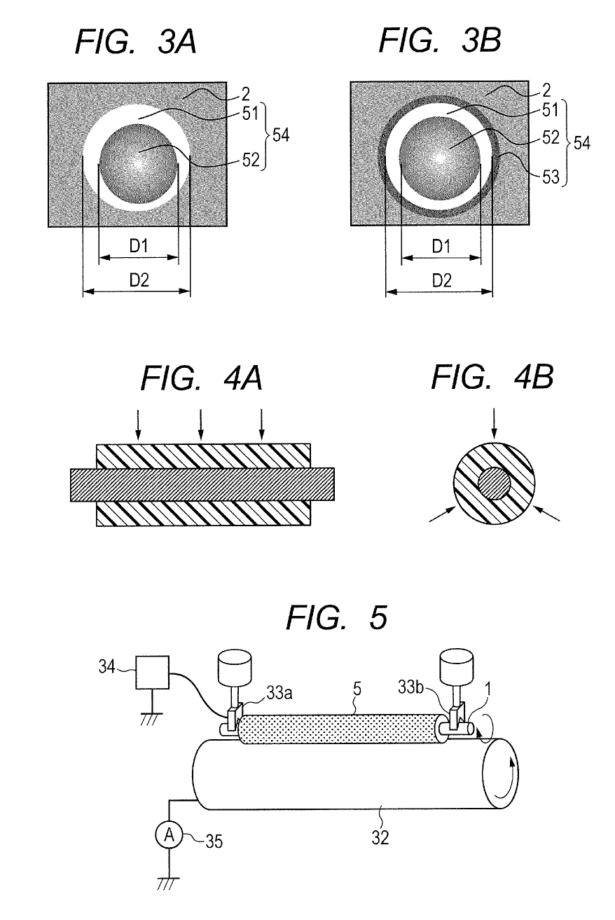

FIGS. 3A and 3B illustrate enlarged views of the closed cell 51. In FIG. 3A, the particle 52 is included in the closed cell 51 so as not to be fixed to an inner wall of the closed cell, and the closed cell 51 has a bell-like structure 54 as a whole. Further, FIG. 3B illustrates a hollow particle structure in which the closed cell 51 has a shell 53. The particle 52 is included in the hollow particle structure in a state of not being fixed to the shell (hereinafter sometimes referred to as “non-fixed state”), and the closed cell 51 has the bell-like structure as a whole. In any of these embodiment modes, the effect of the present invention can be exhibited by virtue of the bell-like structure. A method of producing the elastic layer is described later in detail.

When the volume-average particle diameter of the particle 52 is defined as D1 and the volume-average diameter of the closed cell 51 is defined as D2, it is preferred that (D1/D2)³ be 0.1 or more and 0.8 or less. By setting the volume-average particle diameters in this range, the particle 52 supports the closed cell 51 when left to stand for a long period of time, and compression deformation can be suppressed effectively with a repulsion force in a space within the bell-like structure. Further, it is preferred that D2 be 20 μm or more and 200 μm or less. By setting D2 in this range, ensuring of a nip width in the image-forming process, and suppression of compression deformation in the elastic layer when left to stand for a long period of time can be achieved effectively.

(Rubber Elastic Material)

Known rubber materials can each be used as a rubber elastic material to be used in the elastic layer 2. Examples of the rubber material include natural rubbers, vulcanized natural rubbers, and synthetic rubbers.

An ethylene-propylene rubber, a styrene-butadiene rubber (SBR), a silicone rubber, a urethane rubber, an isoprene rubber (IR), a butyl rubber, an acrylonitrile-butadiene rubber (NBR), a chloroprene rubber (CR), an acrylic rubber, an epichlorohydrin rubber, and a fluororubber can be used as the synthetic rubbers.

Those materials may be used alone or as a mixture of two or more kinds thereof. Further, monomers which are raw materials for those rubber elastic materials may be copolymerized to be used as a copolymer.

(Particle)

It is preferred that the particle 52 to be included in the closed cell 51 be a particle having strength capable of suppressing excess compression and deformation of the closed cell when the elastic layer is compressed. Examples of the particle capable of forming such particle are as follows.

That is, for example, there are given: particles of zinc oxide, tin oxide, indium oxide, titanium oxides (such as titanium dioxide and titanium monoxide), iron oxide, strontium titanate, calcium titanate, magnesium titanate, barium titanate, calcium zirconate, barium sulfate, molybdenum disulfide, calcium carbonate, magnesium carbonate, dolomite, talc, kaolin clay, mica, aluminum hydroxide, magnesium hydroxide, zeolite, wollastonite, diatomaceous earth, glass beads, bentonite, montmorillonite, an organic metal compound, and an organic metal salt; iron oxides such as ferrite, magnetite, and hematite and active carbons; and particles formed of polymer compounds.

In this case, specific examples of the polymer compounds may include: resins such as a polyamide resin, a silicone resin, a fluororesin, a (meth)acrylic resin, a styrene resin, a phenol resin, a polyester resin, a melamine resin, a urethane resin, an olefin resin, an epoxy resin, and copolymers, modified products, and derivatives thereof; and thermoplastic elastomers such as a polyolefin-based thermoplastic elastomer, a urethane-based thermoplastic elastomer, a polystyrene-based thermoplastic elastomer, a fluororubber-based thermoplastic elastomer, a polyester-based thermoplastic elastomer, a polyamide-based thermoplastic elastomer, a polybutadiene-based thermoplastic elastomer, an ethylene-vinyl acetate-based thermoplastic elastomer, a polyvinyl chloride-based thermoplastic elastomer, and a chlorinated polyethylene-based thermoplastic elastomer.

As long as the particle 52 itself has required strength, the particle 52 may have a solid structure, a hollow structure, or a porous structure.

It is preferred that the content of the particles 52 in the elastic layer be 2 parts by mass or more and 30 parts by mass or less with respect to 100 parts by mass of the elastic layer.

(Preparation of Particle Precursor for Forming Elastic Layer)

A method of forming the elastic layer 2 according to the present invention and a method of preparing a particle precursor are hereinafter described.

### First Embodiment

A first exemplary embodiment of a method of producing an elastic layer including closed cells including particles so that the particles are not fixed to inner walls of the closed cells according to the present invention is described below.

First, a particle precursor in which the particle 52 is impregnated with a volatile substance is prepared. In this case, an example of the volatile substance is a substance which is a liquid at normal temperature and which is evaporated by heating during molding of an elastic layer. Then, a mixture for forming an elastic layer containing the particle precursor and rubber is prepared. Then, a layer of the mixture for forming an elastic layer is formed on the surface of an electro-conductive substrate or the surface of another layer formed on the surface of the electro-conductive substrate. Then, the layer of the mixture for forming an elastic layer is heated to cross-link the rubber in the layer of the mixture for forming an elastic layer. Due to the heat applied at this time, an included substance with which the particle precursor is impregnated is evaporated, and the evaporated included substance forms a gap at an interface between the particle precursor and the rubber around the particle precursor, which is being cross-linked. After that, when the cross-linking of the rubber is completed, a gap is present between the particle 52 in which the evaporation of the included substance has been completed and the cross-linked rubber around the particle 52. As a result, a rubber elastic layer is formed in which the particle 52 is present in the gap, that is, a closed cell so that the particle 52 is not fixed to an inner wall of the closed cell. In this method, the size of a cell can be adjusted by the kind and amount of the included substance with which the particle 52 is impregnated.

Specific examples of the liquid which can be used as the included substance are as follows.

For example, there are given water, n-hexane, isohexane, n-heptane, n-octane, isooctane, n-decane, and isodecane. Further, as a foaming agent, for example, there are given: organic foaming agents such as dinitrosopentamethylenetetramine (DPT), azodicarbonamide (ADCA), p-toluenesulfonyl hydrazine (TSH), azobisisobutyronitrile (AIBN), and 4,4′-oxybis(benzenesulfonyl hydrazine) (OBSH); and inorganic foaming agents such as sodium bicarbonate.

It is preferred that the particle 52 be a particle having a porous structure so as to be impregnated with a volatile substance efficiently.

An example of the particle having a porous structure is a porous resin particle.

The porous resin particle can be produced by any of known production methods such as a suspension polymerization method, an interfacial polymerization method, an interfacial precipitation method, a drying-in-liquid method, and a deposition method involving adding a solute and a solvent for lowing the solubility of a resin to a resin solution. For example, in the suspension polymerization method, a non-polymerizable solvent is dissolved in a monofunctional polymerizable monomer or a cross-likable monomer in the presence of a polyfunctional polymerizable monomer, and aqueous suspension polymerization is performed in an aqueous solvent containing a surfactant or a dispersion stabilizer. After the completion of the polymerization, water and the non-polymerizable solvent can be removed by washing and drying steps to obtain a porous resin particle. It is to be noted that a compound having a reactive group which reacts with a functional group of the polymerizable monomer, an organic filler, or the like can also be added.

A (meth)acrylic monomer may be used as the monofunctional polymerizable monomer. Further, as other monomers, for example, there may be used: styrene and derivatives thereof, such as styrene, o-methylstyrene, m-methylstyrene, p-methylstyrene, p-ethylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, n-methoxystyrene, p-phenylsytrene, p-chlorostyrene, and 3,4-dichlorostyrene; ethylene unsaturated monoolefins such as ethylene, propylene, butylene, and isobutylene, vinyl halides such as vinyl chloride, vinylidene chloride, vinyl bromide, and vinyl fluoride; and vinyl esters such as vinyl acetate, vinyl propionate, and vinyl butyrate.

As the (meth)acrylic monomer, for example, there may be used: α-methylene aliphatic monocarboxylates such as methyl acrylate, ethyl acrylate, n-butyl acrylate, isobutyl acrylate, propyl acrylate, n-octyl acrylate, dodecyl acrylate, 2-ethylhexyl acrylate, stearyl acrylate, 2-chloroethyl acrylate, phenyl acrylate, methyl α-chloroacrylate, methyl methacrylate, ethyl methacrylate, propyl methacrylate, n-butyl methacrylate, isobutyl methacrylate, n-octyl methacrylate, dodecyl methacrylate, 2-ethylhexyl methacrylate, stearyl methacrylate, phenyl methacrylate, dimethylaminoethyl acrylate, dimethylaminoethyl methacrylate, diethylaminoethyl acrylate, and diethylaminoethyl methacrylate; and derivatives of acrylic acid and methacrylic acid, such as acrylonitrile, methacrylonitrile, acrylamide, methacrylamide, 2-hydroxyethyl acrylate, 2-hydroxypropyl acrylate, 2-hydroxyethyl methacrylate, and 2-hydroxypropyl methacrylate. In some cases, acrylic acid, methacrylic acid, maleic acid, or fumaric acid may also be used. However, methyl methacrylate is preferred. Those monofunctional polymerizable monomers may be used alone or in combination of two or more kinds thereof.

Examples of the cross-linkable monomer include ester (meth)acrylic monomers such as ethylene glycol di(meth)acrylate, diethylene glycol di(meth)acrylate, triethylene glycol di(meth)acrylate, decaethylene glycol di(meth)acrylate, pentadecaethylene glycol di(meth)acrylate, 1,3-butylene glycol di(meth)acrylate, 1,4-butanediol di(meth)acrylate, 1,6-hexanediol di(meth)acrylate, glycerin di(meth)acrylate, trimethylolpropane tri(meth)acrylate, pentaerythritol tetra(meth)acrylate, diethylene glycol di(meth)acrylate phthalate, hexa(meth)acrylate of caprolactone modified dipentaerythritol, diacrylate of caprolactone modified neopentylglycol hydroxypivalate ester, polyester acrylate, and urethane acrylate; and divinylbenzene, divinylnaphthalene, and derivatives thereof such as an aromatic divinyl-based monomer. Those cross-linkable monomers may be used alone or in combination of two or more kinds thereof.

The non-polymerizable organic solvent is not particularly limited, and for example, there may be used toluene, benzene, ethyl acetate, butyl acetate, n-hexane, n-octane, and n-dodecane. Those non-polymerizable organic solvents may be used alone or in combination of two or more kinds thereof.

The polymerization initiator is not particularly limited, and is preferably an initiator soluble in the polymerizable monomer. For example, there may be used a known peroxide initiator and a known azo initiator. Of those, an azo initiator is preferred, 2,2′-azobisisobutyronitrile, 1,1′-azobiscyclohexane-1-carbonitrile, 2,2′-azobis-4-methoxy-2,4-dimethylvaleronitrile, and 2,2′-azobis-2,4-dimethylvaleronitrile are more preferred, and 2,2′-azobisisobutyronitrile is particularly preferred. In the case of the polymerization initiator, the polymerization initiator is preferably used in an amount of 0.01 part by mass or more and 5 parts by mass or less with respect to 100 parts by mass of the polymerizable monomer.

As the surfactant, for example, there may be used: anionic surfactants such as a sodium lauryl polyoxyethylene ether sulfate (degree of polymerization: 1 to 100), a sodium lauryl polyoxyethylene ether sulfate (degree of polymerization: 1 to 100), and triethanolamine lauryl sulfate; cationic surfactants such as stearyltrimethylammonium chloride, diethylaminoethylamide lactate stearate, dilaurylamine hydrochloride, and oleylamine lactate; nonionic surfactants such as an adipic acid-diethanolamine condensate, lauryldimethylamine oxide, glycerin monostearate, sorbitan monolaurate, and diethylaminoethylamide lactate stearate; and amphoteric surfactants such as cocoamidopropyl betaine, laurylhydroxysulfobetaine, and sodium (3-laurylaminopropionate. Further, polymer dispersants such as polyvinyl alcohol, starch, and carboxymethylcellulose may also be used. In the case of using the surfactant, it is preferred that the surfactant be used in amount of 0.01 part by mass or more and 10 parts by mass or less with respect to 100 parts by mass of the polymerizable monomer.

Examples of the dispersion stabilizer include organic fine particles such as polystyrene fine particles, polymethyl methacrylate fine particles, polyacrylic acid fine particles, and polyepoxide fine particles, silica such as colloidal silica, calcium carbonate, calcium phosphate, aluminum hydroxide, barium carbonate, and magnesium hydroxide. In the case of using the dispersion stabilizer, it is preferred that the dispersion stabilizer be used in an amount of 0.01 part by mass or more and 20 parts by mass or less with respect to 100 parts by mass of the polymerizable monomer.

It is preferred that the suspension polymerization be performed in a sealed state through use of a pressure-tight container. Further, after suspension in a dispersing machine or the like, suspension polymerization may be performed in a pressure-tight container, or suspension may be performed in a pressure-tight container. It is preferred that the polymerization temperature be 50° C. or more and 120° C. or less. Although the polymerization may be performed at an atmospheric pressure, the polymerization is preferably performed under increased pressure (under increased pressure obtained by adding 0.1 MPa or more and 1 MPa or less to an atmospheric pressure) so that a non-polymerizable solvent does not become a gas. After the completion of the polymerization, solid-liquid separation, washing, and the like may be performed by centrifugation, filtration, and the like. In the case of performing solid-liquid separation and washing, drying and crushing may be performed later at a temperature equal to or lower than the softening temperature of a resin constituting a porous resin particle. Drying and crushing can be performed by a known method, and a flash dryer, a fair wind dryer, a Nauta mixer, or the like can be used. Further, drying and crushing can also be performed simultaneously with a grinding dryer or the like. The surfactant and the dispersion stabilizer can be removed by repeating washing filtration or the like after production.

As a method of impregnating the particle 52 with a volatile substance, in the case where the volatile substance is a liquid, the particle 52 can be impregnated with the volatile substance by being placed in the liquid. Further, in the case where the volatile substance is a solid at normal temperature, for example, a dispersion in which the volatile substance is dispersed in an appropriate dispersion medium is prepared, and the particle 52 is placed in the dispersion to be impregnated with the volatile substance. In this case, examples of the dispersion medium include toluene, benzene, ethyl acetate, and butyl acetate. When the inside of the particle is impregnated with the volatile substance, it is preferred to perform an ultrasonic treatment. By performing the ultrasonic treatment, the impregnation amount of an included substance in the particle 52 can be controlled uniformly. Further, by adjusting the time of the ultrasonic treatment, the impregnation amount of the included substance can be adjusted. Thus, a particle precursor in which the particle 52 is impregnated with the included substance can be obtained.

### Second Embodiment

A second exemplary embodiment of a method of producing an elastic layer including closed cells including particles so that the particles are not fixed to inner walls of the closed cells according to the present invention is described below.

First, a particle precursor in which the particle 52 is coated with a foaming agent is prepared. Then, a mixture for forming an elastic layer containing the particle precursor and rubber is prepared. Then, a layer of the mixture for forming an elastic layer is formed on the surface of an electro-conductive substrate or the surface of another layer formed on the surface of the electro-conductive substrate. Then, the layer of the mixture for forming an elastic layer is heated to cross-link the rubber in the layer of the mixture for forming an elastic layer. When the foaming agent with which the particle precursor is coated is foamed by the heat at this time, a generated gas forms a gap at an interface between the particle precursor and the rubber around the particle precursor, which is being cross-linked. After that, when the cross-linking of the rubber is completed, a gap is present between the particle 52 and the cross-linked rubber around the particle 52. As a result, a rubber elastic layer is formed in which the particle 52 is present in the gap, that is, a closed cell so that the particle 52 is not fixed to an inner wall of the closed cell.

The size of the cell can be adjusted by the kind and amount of the foaming agent with which the particle 52 is coated. An example of the foaming agent is a foaming agent used in the above-mentioned first embodiment.

An example using a silicone particle as the particle 52 is hereinafter described. The silicone particle is formed of a spherical silicone cured substance having a linear organopolysiloxane block in a molecular structure formula.

The silicone particle may contain a silicone oil, an organosilane, an ionorganic powder, an organic powder, and the like in its particle.

It is preferred to produce the silicone particle through use of a composition capable of subjecting a vinyl group-containing organopolysiloxane (a) and an organohydrogenpolysiloxane (b) to addition reaction in the presence of a platinum-based catalyst (c), and curing the reaction product.

It is necessary that the component (a) have at least two vinyl groups bonded to a silicon atom in one molecule, and it is preferred that the vinyl groups be present at least at terminals of the molecule. Further, the molecular structure may be a linear structure or a branched structure, or a mixture thereof. Although there is no particular limit to the molecular weight of the component (a), it is preferred that the viscosity at a temperature of 25° C. be 1 cP or more in order that a cured substance becomes a rubber elastic body.

The component (b) is a cross-linking agent of the component (a) and is cured when a hydrogen atom bonded to a silicon atom in this component undergoes addition reaction with a vinyl group in the component (a) due to the catalytic function of the component (c). It is necessary that the component (b) have at least two hydrogen atoms bonded to a silicon atom in one molecule. There is no particular limit to the molecular structure of the component (b), and the molecular structure may be a linear structure, a branched structure, or a cyclic structure, or a mixture thereof. Although there is no particular limit to the molecular weight of the component (b), it is preferred that the viscosity at a temperature of 25° C. be 1 cP or more and 10,000 cP or less in order to make the compatibility with the component (a) satisfactory. Further, regarding the addition amount of this component, it is preferred that the number of hydrogen atoms bonded to a silicon atom in this component be 0.5 or more and 20 or less with respect to one vinyl group in the component (a).

The component (c) is a catalyst for subjecting a vinyl group bonded to a silicon atom and a hydrogen atom bonded to a silicon atom to addition reaction, and examples thereof include platinum-carrying carbon or silica, chloroplatinic acid, a platinum-olefin complex, a platinum-alcohol complex, a platinum-phosphorus complex, and a platinum coordination compound. It is preferred that the use amount of this component be 1 ppm or more and 100 ppm in terms of the amount of platinum atoms with respect to the component (a).

The silicone particle can be produced by reacting the component (a) with the component (b) in the presence of the component (c) and curing the reaction product. Curing can be performed by, for example, a method of curing the component (a) and the component (b) in spray drying at high temperature, a method of curing the components in an organic solvent, or a method of curing the components after forming the components into an emulsion. Of those, a method of curing the components in emulsion particles of silicone is preferred.

Predetermined amounts of a vinyl group-containing organopolysiloxane as the component (a) and an organohydrogenpolysiloxane as the component (b) are mixed to prepare an organopolysiloxane composition. Then, water and a surfactant are added to the obtained composition, and the mixture is emulsified through use of a homomixer or the like. As the surfactant to be used in this case, non-ionic surfactants such as a polyoxyethylene alkyl phenyl ether, a polyoxyethylene alkyl ether, a polyoxyethylene sorbitan fatty acid ester, and a glycerin fatty acid ester are preferred. It is preferred that the addition amount of the surfactant fall within the range of 0.01 part by mass or more and 20 parts by mass of less with respect to 100 parts by mass of an emulsion.

It is preferred that the contents of the vinyl group-containing organopolysiloxane as the component (a) and the organohydrogenpolysiloxane as the component (b) in the emulsion fall within the range of 1 part by mass or more and 80 parts by mass or less. It is to be noted that, in the case where the silicone rubber spherical fine particles contain a silicone oil, a silane, an inorganic powder, an organic powder, and the like, these components only need to be mixed in the organopolysiloxane composition during emulsification.

Then, the platinum-based catalyst as the component (c) is added to the emulsion thus prepared to cure the organopolysiloxane as a dispersion element of a silicone cured substance. A known reaction control agent may be added to the platinum-based catalyst, and in the case where the platinum-based catalyst and the reaction control agent are hardly dispersed in water, the known reaction control agent may be added to the platinum-based catalyst after they are allowed to be dispersed in water through use of a surfactant. An aqueous dispersion may be subjected to solid-liquid separation, washing, and the like by centrifugation, filtration, and the like.

As a method of coating the particle 52 with a foaming agent, there is a method involving suspending the particle 52 in a dispersion of a foaming agent and evaporating the dispersion. Although the dispersion is not particularly limited, examples thereof include alcohols such as methanol and ethanol. By adjusting the foaming agent concentration of the dispersion, the coating amount of the foaming agent to the particle 52 can be adjusted.

Thus, a particle precursor in which the particle 52 is coated with a foaming agent can be obtained.

### Third Embodiment

A third exemplary embodiment of a method of producing an elastic layer having closed cells including particles so that the particles are not fixed to inner walls of the closed cells according to the present invention is described below. In this embodiment, first, a particle 54 having a so-called bell-like structure is prepared in which a particle 52 is included in a hollow particle 51 having a shell 53 so that the particle 52 is not fixed to a shell inner wall. Then, a mixture for forming an elastic layer containing the particle 54 and a rubber material is prepared.

Next, a layer of the mixture for forming an elastic layer is formed on the surface of an electro-conductive substrate or the surface of another layer formed on the surface of the electro-conductive substrate. Then, the layer of the mixture for forming an elastic layer is heated to cross-link rubber in the layer of the mixture for forming an elastic layer. Thus, a rubber elastic layer is formed in which the particle 52 is present in the closed cell so that the particle 52 is not fixed to an inner wall of the closed cell.

A method of preparing the particle 54 having a bell-like structure according to this embodiment is hereinafter described.

A method of producing the particle having a bell-like structure is divided into a primary emulsification step, a secondary emulsification step, a polymerization step, and an included solvent removal step.

In the primary emulsification step, to a monomer solution containing a monomer component and a polymerization initiator, a nuclear particle dispersion, in which nuclear particles are dispersed in a polar solution insoluble in the monomer solution, is added, followed by stirring, to prepare an emulsion in which liquid droplets made of the nuclear particle dispersion are dispersed in the monomer solution. The size of a hollow portion of a particle with a bell-like structure to be obtained corresponds to the size of the liquid droplet made of the nuclear particle dispersion obtained in the primary emulsification step.

In the secondary emulsification step, the emulsion is added to the polar solution insoluble in a monomer solution and stirred to prepare an emulsion in which liquid droplets made of a monomer solution including the nuclear particle dispersion are dispersed in the polar solution insoluble in a monomer solution. The emulsification method is not particularly limited, and a conventionally known method can be used.

In the polymerization step, the monomer component is polymerized to obtain a resin particle including the nuclear particle dispersion. Through the polymerization step, the monomer component is polymerized and a portion of a shell of a bell-like particle is formed. The polymerization method is not particularly limited. An optimum method may be selected appropriately depending on the kind of a monomer component and a polymerization initiator, and it is generally preferred to heat the monomer component.

In the included solvent removal step, the included polar solution is removed from the resin particle including the nuclear particle dispersion to obtain a bell-like particle. Although the method of removing the included solvent is not particularly limited, vacuum drying or the like is suitable. Through the vacuum drying, the polar solution included in the bell-like particle evaporates from a gap of molecules of a shell made of a resin or from a cell in the case where the monomer solution contains a non-polymerizable organic solvent.

Examples of the monomer component include a monofunctional polymerizable monomer used in the porous resin particle, and a cross-linkable monomer.

An example of the polymerization initiator is a polymerization initiator used in the porous resin particle.

It is preferred that the monomer solution contain a lipophilic emulsifier. When the monomer solution contains a lipophilic emulsifier, emulsification stability of an emulsion to be obtained in the primary emulsification step can be further enhanced. The lipophilic emulsifier is not particularly limited, and examples thereof include a polyoxyethylene alkyl ether, a polyoxyethylene fatty acid ester, a sorbitan fatty acid ester, a polyoxyethylene sorbitan fatty acid ester, a glycerin fatty acid ester, a polyglycerin fatty acid ester, and a propyleneglycol fatty acid ester. In the case of using the lipophilic emulsifier, it is preferred that the lipophilic emulsifier be used in an amount of 0.01 part by mass or more and 50 parts by mass or less with respect to 100 parts by mass of the monomer component.

The monomer solution may further contain a non-polymerizable organic solvent. When the monomer solution contains a non-polymerizable organic solvent, the size of a cell of a shell of a bell-like particle to be obtained can be adjusted. An example of the non-polymerizable organic solvent is a non-polymerizable organic solvent used in the porous resin particle. In the case where the non-polymerizable organic solvent is blended into the monomer solution, it is preferred that the non-polymerizable organic solvent be blended in an amount of 400 parts by mass or less with respect to 100 parts by mass of the monomer component.

The nuclear particle dispersion is a liquid in which nuclear particles are dispersed in the polar solution insoluble in a monomer solution. The term “insoluble” as used herein means being completely separated to form a different phase when mixed, and also includes the case where solutions are dissolved in each other in a trace amount. Although there is no particular limit to the polar solution insoluble in a monomer solution to be used in the primary emulsification step as long as the polar solution is insoluble in the monomer solution, water and a polyol such as glycerin are suitable. It is preferred that the polar solution insoluble in a monomer solution contain an aqueous polymerization inhibitor. When the polar solution contains an aqueous polymerization inhibitor, even in the case where the monomer solution is slightly dissolved in the polar solution insoluble in a monomer solution, polymerization can be suppressed. Examples of the aqueous polymerization inhibitor include sodium nitrite, copper chloride, iron chloride, titanium chloride, and hydroquinone.

There is no particular limit to the nuclear particles as long as they can be dispersed in the polar solution insoluble in a monomer solution. Examples of the nuclear particles include those which are illustrated as the particles 52.

In the primary emulsification step, the nuclear particle dispersion is added to the monomer solution and emulsified with stirring. There is no particular limit to the method of emulsification, and a conventionally known method can be used. As the polar solution insoluble in a monomer solution to be used in the secondary emulsification step, those similar to that used in the primary emulsification step can be used. The polar solution may be the same as or different from that used in the primary emulsification step.

The size of each closed cell 51 in the elastic layer according to this embodiment can be adjusted by changing the particle size of the bell-like particle 54.

(Formation of Elastic Layer)

The elastic layer can be formed by bonding a sheet- or tube-shaped layer formed so as to have a predetermined thickness in advance to the electro-conductive substrate, or by coating the substrate with the layer. Alternatively, the elastic layer can be produced by integrally extruding the electro-conductive substrate and the materials for the elastic layer with an extruder provided with a crosshead.

A known method such as mixing with a ribbon blender, a Nauta mixer, a Henschel mixer, a Super mixer, a Banbury mixer, a pressure kneader, or the like can be employed as a method of dispersing the particle precursor in rubber elastic materials to be used for the elastic layer in the present invention.

In the case of using the particles precursor according to the first and second embodiments, it is preferred to heat the particle precursor so as to form a cell around a particle. At this time, in order to suppress deformation during foaming, it is preferred to perform heating with molding with a die or the like.

It is preferred that the volume resistivity of the elastic layer be 1×10² Ω·cm or more and 1×10¹⁰ Ω·cm or less in an environment of a temperature of 23° C. and a humidity of 50% RH. The volume resistivity of the elastic layer is determined as follows. First, an elastic layer is cut into a strip shape measuring about 5 mm by 5 mm by 1 mm. A metal is deposited on both surfaces of the strip so that an electrode and a guard electrode may be produced. Thus, a sample for measurement is obtained. A voltage of 200 V is applied to the resultant sample for measurement with a microammeter (trade name: ADVANTEST R8340A ULTRA HIGH RESISTANCE METER, manufactured by Advantest Corporation). Then, a current after a lapse of 30 seconds is measured, and the volume resistivity is determined by calculation from the thickness and an electrode area. The volume resistivity of the elastic layer can be adjusted with conductive fine particles and an ion conductive agent. Further, the average particle diameter of the conductive fine particles is more preferably 0.01 μm or more and 0.9 μm or less, still more preferably 0.01 μm or more and 0.5 μm or less. As long as the average particle diameter falls within the range, it becomes easy to control the volume resistivity of the elastic layer.

In addition, an additive such as a plasticizing oil or a plasticizer may be added to the elastic layer for adjusting its hardness or the like. The plasticizer or the like is blended in an amount of preferably 1 part by mass or more and 30 parts by mass or less, more preferably 3 parts by mass or more and 20 parts by mass or less with respect to 100 parts by mass of the rubber elastic materials. A plasticizer of a polymer type is more preferably used as the plasticizer. The polymer plasticizer has a weight average molecular weight of preferably 2,000 or more, more preferably 4,000 or more.

The hardness of the elastic layer is preferably 70° or less, more preferably 60° or less in terms of microhardness (Model MD-1). It is to be noted that the term “microhardness (Model MD-1)” refers to the hardness of the elastic layer measured with an ASKER micro-rubber hardness meter (trade name: MD-1 capa, manufactured by KOBUNSHI KEIKI CO., LTD.). Specifically, the hardness is a value of the elastic layer, which has been left to stand in an environment of a temperature of 23° C. and a humidity of 50% RH for 12 hours or more, measured with the hardness meter according to a 10-N peak hold mode.

The elastic layer may be subjected to a surface treatment. A surface processing treatment with UV or an electron beam, and a surface modification treatment involving causing a compound or the like to adhere to the surface and/or impregnating the surface with the compound or the like can be given as examples of the surface treatment.

(Electro-Conductive Substrate)

An electro-conductive substrate to be used in the electro-conductive member of the present invention has conductivity and has a function of supporting a conductive resin layer or the like to be provided on the electro-conductive substrate. As a material for the electro-conductive substrate, there may be given metals such as iron, copper, stainless steel, aluminum, and nickel, and alloys thereof.

(Conductive Resin Layer)

A conductive resin layer may be formed on the elastic layer of the electro-conductive member of the present invention.

As a binder to be used in the conductive resin layer, it is preferred to use a resin from the viewpoints of not contaminating a photosensitive member and other members and having high releasability. Any known binder resin may be adopted as a binder resin. For example, a resin such as a thermosetting resin or a thermoplastic resin may be used. Of those, a fluororesin, a polyamide resin, an acrylic resin, a polyurethane resin, an acrylic urethane resin, a silicone resin, a butyral resin, and the like are more preferred. Those resins may be used alone or as a mixture of two or more kinds thereof. Further, copolymers obtained by copolymerizing monomers which are raw materials for the resins may be used.

The electrical resistance of the elastic layer is set as described above, and hence it is more preferred that the volume resistivity of the conductive resin layer be 1×10³ Ω·cm or more and 1×10¹⁵ Ω·cm or less in an environment of a temperature of 23° C. and a humidity of 50% RH.

The volume resistivity of the conductive resin layer is determined as follows. First, a conductive resin layer is peeled from a charging roller and cut into a strip shape measuring about 5 mm by 5 mm. A metal is deposited on both surfaces of the strip so that an electrode and a guard electrode may be produced. Thus, a sample for measurement is obtained. Alternatively, a conductive resin layer coating film is formed on an aluminum sheet by coating, and a metal is deposited on the coating film surface to obtain a sample for measurement. The sample for measurement thus obtained can be measured in the same way as in the method of measuring the volume resistivity of the elastic layer.

The volume resistivity of the conductive resin layer can be adjusted with a conductive agent such as an ion conductive agent or an electron conductive agent.

The thickness of the conductive resin layer is preferably 0.1 μm or more and 100 μm or less, more preferably 1 μm or more and 50 μm or less.

It is to be noted that the thickness of the conductive resin layer can be measured by cutting out a section of the roller at a position illustrated in each of FIGS. 4A and 4B with a keen cutting tool, and observing the section with an optical microscope or an electron microscope.

The conductive resin layer may be subjected to a surface treatment. A surface processing treatment with UV or an electron beam, and a surface modification treatment involving causing a compound or the like to adhere to the surface and/or impregnating the surface with the compound or the like can be given as examples of the surface treatment.

The conductive resin layer can be formed by an application method such as electrostatic spray application or dipping application. Alternatively, the conductive resin layer can be formed by bonding or coating a sheet- or tube-shaped layer formed so as to have a predetermined thickness in advance. Alternatively, a method involving curing a material in a mold to mold the material into a predetermined shape can be employed. Of those, the following is preferred. A coating is applied by an application method so that a coating film may be formed.

When the layer is formed by the application method, a solvent to be used in the application liquid is not particularly limited as long as it is a solvent capable of dissolving the binder. Specific examples thereof include: alcohols such as methanol, ethanol, and isopropanol; ketones such as acetone, methyl ethyl ketone, and cyclohexanone; amides such as N,N-dimethylformamide and N,N-dimethylacetamide; sulfoxides such as dimethyl sulfoxide; ethers such as tetrahydrofuran, dioxane, and ethylene glycol monomethyl ether; esters such as methyl acetate and ethyl acetate; and aromatic compounds such as xylene, ligroin, chlorobenzene, and dichlorobenzene.

<Electro-Conductive Member>

In order to make charging of an electrophotographic photosensitive member satisfactory, it is more preferred that the electrical resistance of the electro-conductive member of the present invention be generally 1×10³Ω or more and 1×10¹⁰Ω or less in an environment of a temperature of 23° C. and a humidity of 50% RH.

With reference to FIG. 5, a method of measuring the electrical resistance of the charging roller, which is one of the applications of the electro-conductive member, is described as an example. Both ends of the electro-conductive substrate 1 are brought into abutment with a columnar metal 32 having the same curvature as that of the electrophotographic photosensitive member by loaded bearings 33a and 33b so as to be parallel to the metal. In this state, the columnar metal 32 is rotated with a motor (not shown), and then a DC voltage of −200 V is applied from a stabilized power supply 34 to a charging roller 5 abutting on the metal while the roller is rotated following the rotation of the metal. A current flowing at this time is measured with an ammeter 35, and then the electrical resistance of the charging roller is calculated.

The charging roller of the present invention preferably has such a shape that the charging roller is thickest at a central portion in its longitudinal direction and becomes thinner as the charging roller approaches each of both of its ends in the longitudinal direction, which is so called a crown shape, from the viewpoint of the uniformization of a longitudinal nip width with respect to the electrophotographic photosensitive member. A crown amount is preferably such that a difference between an outer diameter at the central portion and an outer diameter at a position 90 mm away from the central portion is 30 μm or more and 200 μm or less.

The hardness of the surface of the charging roller is preferably 90° or less, more preferably 40° or more and 80° or less in terms of microhardness (Model MD-1). By setting the hardness in this range, it becomes easy to stabilize the abutment between the charging roller and the electrophotographic photosensitive member or other members.

### <Electrophotographic Apparatus>

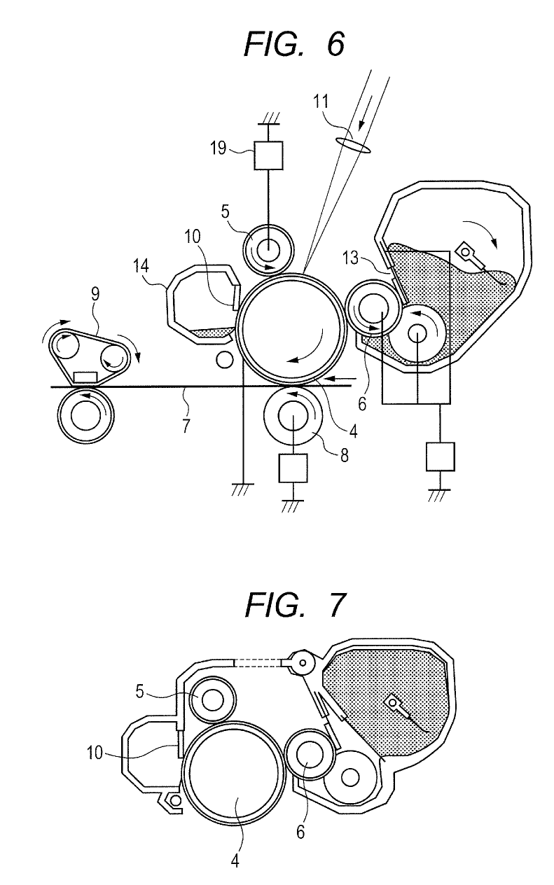

FIG. 6 illustrates a schematic configuration of an example of an electrophotographic apparatus including the conductive roller of the present invention as a charging roller.

The electrophotographic apparatus is formed of, for example, an electrophotographic photosensitive member, a charging device for charging the electrophotographic photosensitive member, a latent image-forming device for performing exposure, a developing device, a transferring device, a cleaning device for recovering transfer toner on the electrophotographic photosensitive member, and a fixing device for fixing the toner image.

An electrophotographic photosensitive member 4 is of a rotating drum type having a photosensitive layer on an electro-conductive substrate. The electrophotographic photosensitive member is rotationally driven in the direction indicated by an arrow at a predetermined circumferential speed (process speed).

The charging device has a contact-type charging roller 5 placed so as to be in contact with the electrophotographic photosensitive member 4 by being brought into abutment with the member at a predetermined pressing force. The charging roller 5 rotates following the rotation of the electrophotographic photosensitive member, and charges the electrophotographic photosensitive member to a predetermined potential by applying a predetermined DC voltage from a power supply for charging 19. When the uniformly charged electrophotographic photosensitive member is irradiated with exposure light 11 corresponding to image information, an electrostatic latent image is formed.

The developing device has a developing sleeve or developing roller 6 placed so as to be close to, or in contact with, the electrophotographic photosensitive member 4. The electrostatic latent image is developed to form a toner image with toner, which has been subjected to an electrostatic treatment so as to have the same polarity as the charged polarity of the electrophotographic photosensitive member, by reversal development. The developing device includes an elastic regulating blade 13.

The transferring device has a contact-type transfer roller 8. The device transfers the toner image from the electrophotographic photosensitive member onto a transfer material 7 such as plain paper (the transfer material is conveyed by a sheet-feeding system having a conveying member).

The cleaning device has a blade-type cleaning member 10 and a recovery container 14, and mechanically scrapes transfer residual toner remaining on the electrophotographic photosensitive member after the transfer to recover the toner. In this case, adopting a simultaneous-with-development cleaning mode according to which the transfer residual toner is recovered in the developing device can eliminate the cleaning device.

A fixing device 9 is formed of a heated roll or the like, and fixes the transferred toner image onto the transfer material 7 and discharges the resultant to the outside of the apparatus.

### <Process Cartridge>

A process cartridge (FIG. 7) obtained by integrating, for example, an electrophotographic photosensitive member, a charging device, a developing device, and a cleaning device, and designed so as to be attachable to and detachable from an electrophotographic apparatus can also be used.

That is, the process cartridge is as described below. A charging member is integrated with a body to be charged, the process cartridge is attachable to and detachable from the main body of the electrophotographic apparatus, and the charging member is the above-mentioned charging roller.

### EXAMPLES

Now, the present invention is described in more detail by way of specific examples. However, the present invention is not limited to these examples.

### Production Example 1

### Production of Particles 1

120 parts by mass of colloidal silica as a dispersion stabilizer were added to 800 parts by mass of deionized water to prepare an aqueous mixed solution. Then, an oily mixed solution made of 60 parts by mass of methyl methacrylate and 40 parts by mass of ethylene glycol dimethacrylate as polymerizable monomers, 100 parts by mass of ethyl acetate as a non-polymerizable solvent, and 0.6 part by mass of benzoyl peroxide as a polymerization initiator was prepared.

The oily mixed solution was dispersed in the aqueous mixed solution at a rotation number of 5,000 rpm with a homomixer. After that, the dispersion thus obtained was loaded in a polymerization reaction container purged with nitrogen, and suspension polymerization was performed with stirring at 200 rpm and then stirring at a temperature of 60° C. for 6 hours to obtain an aqueous suspension containing resin particles and n-hexane. 0.4 part by mass of sodium lauryl sulfate was added to the aqueous suspension to adjust the concentration of the sodium lauryl sulfate to 0.05% by weight with respect to water.

The obtained aqueous suspension was distilled under reduced pressure to remove ethyl acetate. The remaining aqueous suspension was repeatedly subjected to filtration and washing with water, followed by drying at a temperature of 80° C. for 5 hours, to produce a particle precursor 1. The volume average particle diameter of the obtained particle precursor 1 was set to 30 μm by shredding and classification with an acoustic classifier.

10% by weight of the particle precursor 1 were added to n-hexane that was an included substance. The mixed liquid was irradiated with an ultrasonic wave for 3 minutes and subjected to centrifugation at a rotation number of 4,000 rpm for 30 minutes to remove a supernatant, and thereby, particles 1 impregnated with the included substance were obtained (see Table 1).

### Production Examples 2 to 22

### Production of Particles 2 to 22

Particles 2 to 22 were produced by the same method as that of Production Example 1 with the exception that the kind and number of parts of added polymerizable monomers, and an ultrasonic irradiation time were changed as shown in Table 1.

TABLE 1

| | Kind of polymerizable monomer | | | | | | | Ultrasonic |
|---|---|---|---|---|---|---|---|---|
| | Methyl | Ethylene glycol | | | | Particle | | irradiation |
| | methacrylate | dimethacrylate | Styrene | Divinylbenzene | Colloidal silica | diameter | Impregnated | time |
| Particle No. | (parts by mass) | (parts by mass) | (parts by mass) | (parts by mass) | (parts by mass) | (μm) | material | (minute(s)) |
| 1 | 60 | 40 | — | — | 120 | 30 | n-Hexane | 3 |
| 2 | 60 | 40 | — | — | 120 | 30 | n-Hexane | 6 |
| 3 | 60 | 40 | — | — | 120 | 45 | n-Hexane | 1 |
| 4 | 60 | 40 | — | — | 180 | 15 | n-Hexane | 10 |
| 5 | 60 | 40 | — | — | 120 | 48 | n-Hexane | 1 |
| 6 | 60 | 40 | — | — | 80 | 60 | n-Hexane | 6 |
| 7 | 60 | 40 | — | — | 80 | 80 | n-Hexane | 3 |
| 8 | 60 | 40 | — | — | 80 | 65 | n-Hexane | 3 |
| 9 | 60 | 40 | — | — | 80 | 90 | n-Hexane | 1 |
| 10 | 60 | 40 | — | — | 120 | 30 | n-Hexane | 10 |
| 11 | 60 | 40 | — | — | 80 | 94 | n-Hexane | 1 |
| 12 | 60 | 40 | — | — | 180 | 15 | n-Hexane | 10 |
| 13 | 60 | 40 | — | — | 120 | 25 | n-Hexane | 3 |
| 14 | 60 | 40 | — | — | 120 | 27 | n-Hexane | 1 |
| 15 | 60 | 40 | — | — | 180 | 10 | n-Hexane | 10 |
| 16 | 60 | 40 | — | — | 120 | 27 | n-Hexane | 1 |
| 17 | 40 | 30 | 20 | — | 80 | 60 | n-Hexane | 3 |
| 18 | 40 | 30 | 20 | — | 180 | 15 | n-Hexane | 10 |
| 19 | 40 | 30 | 20 | — | 120 | 48 | n-Hexane | 1 |
| 20 | 60 | — | — | 40 | 120 | 30 | n-Hexane | 3 |
| 21 | 60 | — | — | 40 | 180 | 20 | n-Hexane | 10 |
| 22 | 60 | — | — | 40 | 120 | 50 | n-Hexane | 1 |
| 33 | 60 | 40 | — | — | 120 | 30 | — | — |

### Production Example 23

### Production of Particles 23

500 parts by mass of methylvinylsiloxane represented by the following formula (1) and having a viscosity of 600 cS and 20 parts by mass of methylhydrogenpolysiloxane represented by the following formula (2) and having a viscosity of 30 cS were added to a polymerization reaction container and mixed with stirring at 2,000 rpm through use of a homomixer.

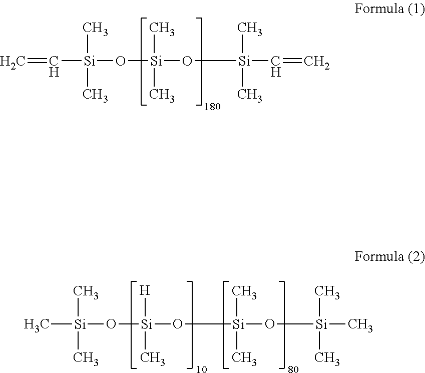

Then, 1 part by mass of polyoxyethylene octyl phenyl ether and 150 parts by mass of water were added to the mixture, and the resultant mixture was stirred at 6,000 rpm. As a result, it was observed that the mixture was thickened. Then, 329 parts by mass of water were added to the mixture with stirring at 2,000 rpm to obtain an O/W type emulsion. The emulsion was transferred to a glass flask equipped with a stirring device having an anchor type stirring blade, and the temperature was adjusted to 15 to 20° C. After that, a mixture of 1 part by mass of a toluene solution (platinum content: 0.05%) of a chloroplatinic acid-olefin complex and 1 part by mass of polyoxyethylene octyl phenyl ether was added to the resultant emulsion, followed by reaction for 12 hours, to obtain a dispersion. The dispersion was dried to obtain a particle precursor 23. The volume average particle diameter of the obtained particle precursor 23 was set to 25 μm by shredding and classification with an acoustic classifier.

Next, a methanol solution (containing 10% by mass of ADCA) of azodicarbonamide (ADCA) that was a foaming agent was prepared. To the methanol solution, 20% by mass of the particle precursor 23 were added, and the mixture was stirred at 200 rpm. After that, methanol was removed to obtain particles 23 coated with the foaming agent (see Table 2).

### Production Examples 24 to 27

### Production of Particles 24 to 27

Particles 24 to 27 were produced by the same method as that of Production Example 23 with the exception that the number of parts of added methylvinylsiloxane, methylhydrogenpolysiloxane, polyoxyethylene octyl phenyl ether were changed as shown in Table 2.

TABLE 2

| | | | | | Number of |
|---|---|---|---|---|---|
| | | | | | parts of |
| | | | | | foaming |
| | Kind of reaction material | | | | agent for |
| | | | Polyoxyethylene octyl | Particle | coating |
| Particle | Methylvinylsiloxane | Methylhydrogensiloxane | phenyl ether | diameter | (part by |
| No. | (part by mass) | (parts by mass) | (parts by mass) | (μm) | mass) |
| 23 | 500 | 20 | 1 | 25 | 10 |
| 24 | 500 | 20 | 0.5 | 40 | 20 |
| 25 | 500 | 20 | 0.5 | 45 | 30 |
| 26 | 500 | 20 | 1 | 15 | 10 |
| 27 | 800 | 15 | 0.5 | 48 | 30 |
| 34 | 500 | 20 | 1 | 15 | — |

### Production Example 28

### Production of Particles 28

A mixed solution containing 400 parts by mass of ion-exchanged water, 8 parts by mass of polyvinyl alcohol (saponification degree: 85%), and 0.04 part by mass of sodium lauryl sulfate was prepared. On the other hand, a mixed solution was prepared in which a mixture containing 0.1 part by mass of ethylene glycol dimethacrylate, 0.5 part by mass of benzoyl peroxide, and 100 parts by mass of methyl methacrylate was dispersed through use of a Viscomill dispersing machine filled with zirconia beads with a diameter (φ) of 0.5 mm. Dispersion was performed at a circumferential speed of 10 m/sec for 60 hours. Then, the two kinds of solutions were loaded in a four-necked flask for two liters equipped with a high-speed stirring device model TK homomixer (manufactured by Tokushu Kika Kogyo Co., Ltd.) and dispersed at a rotation number of 8,000 rpm. After that, the dispersion was loaded in a polymerization vessel having a stirring machine and a thermometer, and a space was purged with nitrogen. Then, the dispersion was continued to be stirred at a temperature of 60° C. for 12 hours (rotation of the stirring machine: 55 rpm) to complete suspension polymerization. After cooling, the suspension was filtered, washed, and dried to obtain nuclear particles 1. The volume average particle diameter of each of the nuclear particles 1 thus obtained was set to 25 μm by shredding and classification with an acoustic classifier.

The nuclear particles 1 were added to ion-exchanged water containing 1% by weight of sodium chloride and 0.02% by weight of sodium nitrite as a water-soluble polymerization inhibitor so that the concentration became 10% by weight. Then, the mixture was stirred at a rotation number of 5,000 rpm with a homomixer to obtain a nuclear particle dispersion. Then, 40 parts by weight of methyl methacrylate and 10 parts by weight of ethylene glycol dimethacrylate as polymerizable monomers, 0.25 part by weight of azobisisobutyronitrile (AIBN) as a polymerization initiator, and 2 parts by weight of glycerin monostearate as a lipophilic emulsifier were prepared. The components were mixed and stirred to prepare a monomer solution. 50 parts by weight of the nuclear particle dispersion were added to the monomer solution thus obtained, and the mixture was stirred and emulsified at a rotation number of 1,000 rpm with a homomixer to obtain a primary dispersion.

Then, 102.25 parts by weight of the primary dispersion thus obtained were added to 300 parts by weight of ion-exchanged water containing 1% by weight of polyvinyl alcohol as a dispersant and 0.02% by weight of sodium nitrite as a water-soluble polymerization inhibitor. The mixture was stirred and emulsified at a rotation number of 3,000 rpm with a homomixer to obtain a secondary dispersion. Then, a polymerization vessel of 20 liters equipped with a stirring machine, a jacket, a reflux cooler, and a thermometer was prepared. The polymerization vessel was reduced in pressure to remove oxygen from the vessel, and a nitrogen atmosphere was established in the vessel. 10 liters of the obtained secondary dispersion was loaded in the polymerization vessel at a time, and the polymerization vessel was raised in temperature to 60° C. to start polymerization with stirring at 200 rpm. After the polymerization for 4 hours, the polymerization vessel was further raised in temperature to 80° C., and the content of the vessel was aged for 1 hour and then cooled to room temperature.

The slurry thus obtained was dehydrated with a dehydration device and dried in vacuum to obtain particles (see Table 3). Particles having a bell-like structure were obtained. The volume average particle diameter of each of the obtained particles 28 was set to 25 μm by shredding and classification with an acoustic classifier.

### Production Examples 29 to 32

### Production of Particles 29 to 32

Particles 29 to 32 were produced by the same method as that of Production Example 28 with the exception that the stirring rotation number during production of nuclear particles, the kind and number of parts of added polymerizable monomers during production of a primary dispersion, and the stirring rotation number of the primary dispersion were changed as shown in Table 3.

TABLE 3

| | Nuclear particles | | | Primary dispersion | | |
|---|---|---|---|---|---|---|
| | | Stirring | | Polymerizable monomer | | Stirring |
| | | rotation | Particle | Methyl | Ethylene glycol | rotation |
| Particle | | number | diameter | methacrylate | dimethacrylate | number |
| No. | Kind | (rpm) | (μm) | (parts by mass) | (parts by mass) | (rpm) |
| 28 | Methyl | 8,000 | 25 | 40 | 10 | 1,000 |
| | methacrylate | | | | | |
| 29 | Methyl | 3,000 | 40 | 40 | 10 | 2,000 |
| | methacrylate | | | | | |
| 30 | Methyl | 3,000 | 45 | 40 | 10 | 3,000 |
| | methacrylate | | | | | |
| 31 | Methyl | 10,000 | 15 | 40 | 10 | 1,000 |
| | methacrylate | | | | | |
| 32 | Methyl | 3,000 | 48 | 40 | 10 | 3,000 |
| | methacrylate | | | | | |

| | | | | |
|---|---|---|---|---|
| 35 | No nuclear particles | 40 | 10 | 1,000 |

### Production Example 33

### Production of Particles 33

Particles 33 were produced by the same method as that of Production Example 1 with the exception that n-hexane was not added to the particle precursor 1.

### Production Example 34

### Production of Particles 34

Particles 34 were produced by the same method as that of Production Example 26 with the exception that the particle precursor 26 was not coated with ADCA.

### Production Example 35

### Production of Particles 35

Particles 35 were produced by the same method as that of Production Example 28 with the exception that nuclear particles were not added.

### Production Example 36

### Production of Conductive Rubber Composition 1 using Acrylonitrile Butadiene Rubber

Materials shown in Table 4 below were kneaded with a closed-type mixer adjusted to a temperature of 50° C. for 15 minutes.

TABLE 4

| | | |
|---|---|---|
| Acrylonitrile butadiene rubber (NBR) | 100 | parts by mass |
| (trade name: N230SV, manufactured by JSR | | |
| CORPORATION) | | |
| Carbon black | 48 | parts by mass |
| (trade name: Toka black #7360SB, | | |
| manufactured by TOKAI CARBON CO., LTD.) | | |
| Zinc stearate | 1 | part by mass |
| (trade name: SZ-2000, manufactured by | | |
| SAKAI CHEMICAL INDUSTRY CO., LTD.) | | |
| Zinc oxide | 5 | parts by mass |
| (trade name: Zinc white type 2, | | |
| manufactured by SAKAI CHEMICAL | | |
| INDUSTRY CO., LTD.) | | |
| Calcium carbonate | 20 | parts by mass |
| (trade name: Silver W, manufactured by | | |
| SHIRAISHI KOGYO CO., LTD.) | | |

10 parts by mass of the particles 1, 1.2 parts by mass of sulfur as a vulcanizing agent, and 4.5 parts by mass of tetrabenzylthiuram disulfide (TBzTD) (trade name: Perkacit TBzTD manufactured by Flexis Co., Ltd.) as a vulcanization accelerator were added to the kneaded materials. The resultant mixture was kneaded with a two-roll machine cooled to a temperature of 25° C. for 10 minutes to produce a conductive rubber composition 1.

### Production Example 37

### Production of Conductive Rubber Composition 2 using Styrene Butadiene Rubber

Materials shown in Table 5 below were kneaded with a closed-type mixer adjusted to a temperature of 80° C. for 15 minutes.

TABLE 5

| | |
|---|---|
| Styrene butadiene rubber (SBR) | 100 parts by mass |
| (trade name: SBR1500, manufactured by | |
| JSR CORPORATION) | |
| Zinc oxide | 5 parts by mass |
| (trade name: Zinc white type 2, | |
| manufactured by SAKAI CHEMICAL INDUSTRY | |
| CO., LTD.) | |
| Zinc stearate | 2 parts by mass |
| (trade name: SZ-2000, manufactured by | |
| SAKAI CHEMICAL INDUSTRY CO., LTD.) | |
| Carbon black | 8 parts by mass |
| (trade name: Ketchen black EC600JD, | |
| manufactured by LION CORPORATION) | |
| Carbon black | 40 parts by mass |
| (Trade name: Ceast S, manufactured by | |
| TOKAI CARBON CO., LTD.) | |
| Calcium carbonate | 15 parts by mass |
| (trade name: silver W, manufactured by | |
| SHIRAISHI KOGYO CO., LTD.) | |
| Paraffin oil | 20 parts by mass |
| (trade name: PW380, manufactured by | |
| IDEMITSU KOSAN CO., LTD.) | |

10 parts by mass of the particles 1, 1 part by mass of sulfur as a vulcanizing agent, and 1 part by mass of dibenzothiazyl sulfide (DM) (trade name: NOCCELER DM, manufactured by Ouchi Shinko Chemical Industrial Co., Ltd.) and 1 part by mass of tetramethylthiuram monosulfide (TS) (trade name: NOCCELER TS, manufactured by Ouchi Shinko Chemical Industrial Co., Ltd.) as vulcanization accelerators were added to the kneaded materials. The resultant mixture was kneaded with a two-roll machine cooled to a temperature of 25° C. for 10 minutes to produce a conductive rubber composition 2.

### Production Example 38

### Production of Conductive Rubber Composition 3 using Acrylonitrile Butadiene Rubber

A conductive rubber composition 3 was produced by the same method as that of Production Example 36 with the exception that 20 parts by mass of the ADCA were added instead of adding the particles 1 in Production Example 36.

### Production Example 39

### Production of Conductive Rubber Composition 4 using Acrylonitrile Butadiene Rubber

A conductive rubber composition 4 was produced by the same method as that of Production Example 36 with the exception that the particles 1 were changed to the particles 33, and 20 parts by mass of the ADCA were added in Production Example 36.

### Production Example 40

### Production of Composite Conductive Fine Particles

140 g of methylhydrogenpolysiloxane were added to 7.0 kg of silica particles (average particle diameter: 15 nm, volume resistivity: 1.8×10¹² Ω·cm), and the resultant was mixed with stirring at a stirring speed of 22 rpm for 30 minutes under a linear load of 588 N/cm (60 kg/cm). 7.0 kg of carbon black “#52” (trade name, manufactured by Mitsubishi Chemical Corporation) were added to the mixture over 10 minutes while an edge runner was being operated, and the resultant was mixed with stirring at a stirring speed of 22 rpm for 60 minutes under a linear load of 588 N/cm (60 kg/cm). Thus, the carbon black was allowed to adhere to the surfaces of the silica particles coated with methylhydrogenpolysiloxane, and thereafter, the resultant silica particles were dried at a temperature of 80° C. for 60 minutes through use of a dryer to produce composite conductive fine particles. The composite conductive fine particles thus obtained each had an average particle diameter of 15 nm and a volume resistivity of 1.1×10² Ω·cm.

### Production Example 41

### Production of Surface-Treated Titanium Oxide Particles

110 g of isobutyltrimethoxysilane as a surface treatment agent and 3,000 g of toluene as a solvent were blended into 1,000 g of needle-like, rutile-type titanium oxide particles (average particle diameter: 15 nm, vertical:horizontal=3:1, volume resistivity: 2.3×10¹⁰ Ω·cm). Thus, a slurry was prepared.

The slurry was mixed with a stirring machine for 30 minutes. After that, the slurry was supplied to a Viscomill 80% of the effective internal volume of which had been filled with glass beads each having an average particle diameter of 0.8 mm, and was then subjected to a wet shredding treatment at a temperature of 35±5° C. The slurry obtained by the wet shredding treatment was distilled under reduced pressure with a kneader (bath temperature: 110° C., product temperature: 30 to 60° C., degree of decompression: about 100 Torr) so that toluene was removed. The remainder was subjected to a treatment for baking the surface treatment agent at a temperature of 120° C. for 2 hours. The particles subjected to the baking treatment were cooled to room temperature, and were then pulverized with a pin mill. Thus, surface-treated titanium oxide particles were produced.

### Production Example 42

### Production of Conductive Resin Coating Liquid 1

Methyl isobutyl ketone was added to a caprolactone-modified acrylic polyol solution “PLACCEL DC2016” (trade name, manufactured by Daicel Chemical Industries, Ltd.) to adjust the solid content of the mixture to 17% by mass. Components shown in Table 6 below were added to 588.24 parts by mass of the solution (acrylic polyol solid content: 100 parts by mass). Thus, a mixed solution was prepared.

TABLE 6

| | | |
|---|---|---|
| Composite conductive fine particles | 45 | parts by mass |
| (produced in Production Example 40) | | |
| Surface-treated titanium oxide particles | 20 | parts by mass |
| (produced in Production Example 41) | | |
| Modified dimethyl silicone oil “SH28PA” | 0.08 | part by mass |
| (trade name, manufactured by DOW CORNING | | |
| TORAY CO., LTD.) | | |
| Block isocyanate mixture | 80.14 | parts by mass |
| (7:3 mixture of butanone oxime block | | |
| bodies of hexamethylene diisocyanate | | |
| (HDI) and isophorone diisocyanate | | |
| (IPDI)) | | |

At this time, the block isocyanate mixture had such an isocyanate amount that the relationship of “NCO/OH=1.0” is satisfied.

Next, 200 g of the mixed solution were loaded into a glass bottle having an internal volume of 450 mL together with 200 g of glass beads each having an average particle diameter of 0.8 mm as media, and then dispersion was performed with a paint shaker dispersing machine for 24 hours. Then, the glass beads were removed. Thus, a conductive resin coating liquid 1 was produced.

### Production Example 43

### Production of Conductive Resin Coating Liquid 2

Methyl ethyl ketone was added to a polyurethane resin “Nippolan 5230” (trade name, manufactured by Nippon Polyurethane Industry Co., Ltd.) to adjust the solid content of the mixture to 20% by mass. 25 parts by mass of carbon black “MA230” (trade name, manufactured by Mitsubishi Chemical Corporation) as a conductive agent were added to 214.29 parts by mass of the solution (polyurethane resin solid content: 100 parts by mass), and the resultant was treated with a ball mill for 5 hours to obtain a resin coating material 2 in which carbon black was dispersed. 40 parts by mass of an alkyl isocyanate-modified polyethyleneimine were added to the resin coating material 2.

Then, 15 parts by mass of urethane particles “Art Pearl C-400T” (trade name, manufactured by Negami Chemical Industrial Co., Ltd.) were added to the mixture, and the resultant mixture was thoroughly stirred. After that, methyl ethyl ketone was added to the mixture to adjust the viscosity to 7 mPa·s to obtain a conductive resin coating liquid 2. The viscosity was measured at a cone rotor rotation number of 20 rpm and at a liquid temperature adjusted to 25° C., through use of an E-type viscometer (RE115L (trade name), manufactured by Toki Sangyo Co., Ltd.) and a standard cone rotor with a cone angle of 1° 34′.

### Example 1

### Charging Roller 1

(Electro-Conductive Substrate)

A stainless-steel substrate having a diameter of 6 mm and a length of 252.5 mm was coated with a thermosetting adhesive containing 10% by mass of carbon black and dried to be used as an electro-conductive substrate.

(Formation of Elastic Layer)

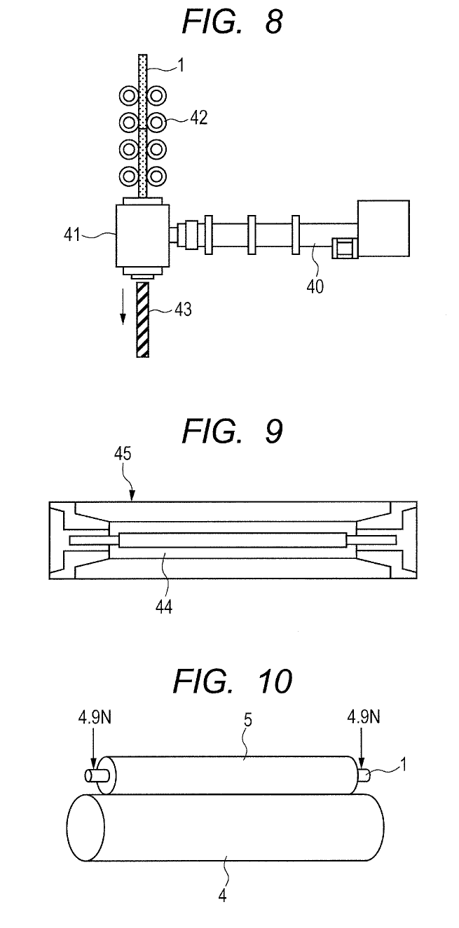

An electro-conductive substrate was coated with the conductive rubber composition 1 produced in Production Example 36 in a cylindrical shape coaxially with the electro-conductive substrate being a center axis, through use of an extruder provided with a crosshead illustrated in FIG. 8 to produce a preform. The thickness of the rubber composition used for the coating was adjusted to 1.75 mm. It is to be noted that, in FIG. 8, an electro-conductive substrate is represented by 1, a feed roller is represented by 42, an extruder is represented by 40, a crosshead is represented by 41, and a roller after extrusion is represented by 43.

The rubber composition at the ends of the preform was removed to expose the ends of the electro-conductive substrate. Then, as FIG. 9 schematically illustrates the preform, the preform was set in a die 45 having a cylindrical cavity 44 with an inner diameter (φ) of 12 mm, and the preform was heated and foamed. The die was heated at a temperature of 160° C. for 20 minutes through use of a heater and a temperature-adjusting device (not shown). Further, the resultant was taken out from the die, and then subjected to secondary vulcanization by heating at a temperature of 160° C. for 30 minutes with a hot-air oven to obtain an elastic roller 1 having an elastic layer with an outer diameter (φ) of 12 mm and a length of 224.2 mm.

(Production of Charging Roller 1)

The conductive resin coating liquid 1 produced in Production Example 42 was applied onto the elastic roller 1 thus produced once by dipping, and was then air-dried at normal temperature for 30 minutes. After that, the resultant was dried with a circulating hot air dryer at a temperature of 80° C. for 1 hour and then at a temperature of 160° C. for an additional one hour. Thus, a charging roller 1 was obtained.

In this case, the dipping application was performed under the conditions of an immersion time of 9 seconds, an initial dip-coating lifting speed of 20 mm/sec, and a final dip-coating lifting speed of 2 mm/sec. The lifting speed was linearly changed with time in the course of the dipping application.

(Measurement of Electrical Resistance of Charging Roller)

The resistance of the charging roller was measured with an instrument for measuring an electrical resistance illustrated in FIG. 5.

First, the charging roller was brought into abutment with a columnar metal 32 (having a diameter of 30 mm) by bearings 33a and 33b so that the charging roller was parallel to the metal.

In this case, an abutment pressure was adjusted to 4.9 N at one end, i.e., a total of 9.8 N at both ends with a spring pressure.

Next, the charging roller was rotated with a motor (not shown) following the columnar metal 32 rotationally driven at a circumferential speed of 45 mm/sec.

During the rotation following the metal, a DC voltage of −200 V was applied from a stabilized power supply 34, and then a value for a current flowing through the charging roller was measured with an ammeter 35. The resistance of the charging roller was calculated from the applied voltage and the current value.

The charging roller was left to stand still in an environment of a temperature of 23° C. and a humidity of 50% RH for 24 hours or more before its electrical resistance was measured. As a result, the electrical resistance of the charging roller 1 was 2.0×10⁵Ω.

(Shape Measurement of Elastic Layer Cross-Section)

An arbitrary point of the elastic layer was cut every 20 nm over 500 μm with focused ion beams (trade name: FB-2000C, manufactured by Hitachi, Ltd.), and then its cross-sectional images were photographed. Then, images obtained by photographing cells and particles were combined to calculate a stereoscopic image.

A particle diameter dl and a closed cell diameter d2 were measured from the stereoscopic image to calculate the volume average particle diameter D1 of the particle and the volume average diameter D2 of the closed cell illustrated in FIGS. 3A and 3B. That is, the particle diameter dl and the closed cell diameter d2 were measured for ten particles and cells in a viewing field, respectively. Then, the same measurement was performed with respect to 10 points in a longitudinal direction of the elastic layer, and average values of a total of 100 particles and cells were respectively calculated to obtain the volume average particle diameter D1 and the volume average diameter D2 of the closed cell.

Further, it was confirmed by the following method that the particles in the closed cells of the elastic layer were not fixed to inner walls of the closed cells.

That is, a center portion in the longitudinal direction of the elastic layer was cut with the focused ion beams (trade name: FB-2000C, manufactured by Hitachi, Ltd.), and a cross-section thereof was observed with a manipulator (trade name: AxisPro Micro Manipulator, manufactured by Micro Support Co., Ltd.).

Then, the particles present in the closed cells in the viewing field were collected through use of a microtool (metallic probe) of the manipulator. Thus, it was confirmed that the particles were not fixed to the inner walls of the closed cells. This operation was performed for closed cells at 10 places in the viewing field. Further, the same operation was also performed for two places at positions of 90 mm away from the center portion in the longitudinal direction of the elastic layer to both ends, respectively. That is, 30 closed cells present in the elastic layer were observed, and it was confirmed that the particles present in the respective closed cells had a bell-like structure in which the particles were not fixed to the inner walls of the closed cells and were movable in the closed cells independently from an elastic body.

(Evaluation of Horizontal Line Image Due to Set)

As an electrophotographic apparatus having a configuration illustrated in FIG. 6, a color laser jet printer (trade name: HP Color LaserJet 4700dn) manufactured by Hewlett-Packard Co. Ltd. was remodeled so as to have an output speed of a recording medium of 200 mm/sec (A4 vertical output) to be used. The image resolution was 600 dpi, and the output of primary charging was a DC voltage of −1,100 V.

As a process cartridge having a configuration illustrated in FIG. 7, a process cartridge (for black) for the printer was used.

An accompanying charging roller was taken out from the above-mentioned process cartridge, and the charging roller according to the present invention was set. The charging roller was brought into abutment with the photosensitive member under a spring pressure of 4.9 N at one end (total 9.8 N at both terminals) (FIG. 10).

The process cartridge was left to stand still for 1 month in an environment of a temperature of 40° C. and a humidity of 95% RH (left to stand under harsh conditions). After that, the process cartridge was left to stand still for 6 hours in an environment of a temperature of 23° C. and a humidity of 50% RH, and then mounted on the above-mentioned electrophotographic apparatus, and an image was output in the same environment. As an evaluation image, a half-tone image (image drawing horizontal lines at a width of one dot in a direction perpendicular to the rotation direction of the photosensitive member at an interval of two dots) was output. The output image was evaluated for its set image based on the criteria described in the Table 7 below. Table 8 shows the evaluation results.

TABLE 7

| | |
|---|---|
| Rank 1 | No set image is generated. |
| Rank 2 | Only a slight stripe-like image is recognized. |
| Rank 3 | Although a stripe-like image is partly recognized |
| | at a pitch of the charging roller, image quality |
| | has no practical problem. |
| Rank 4 | A stripe-like image is conspicuous, and degradation |
| | in image quality is recognized. |

(Measurement of Set Amount)

After outputting an image, the charging roller was taken out from the process cartridge, and radii of the charging roller in a set portion and a non-set portion were respectively measured. For the measurement, an automatic roller measurement apparatus manufactured by Tokyo Opto-Electronics Co., Ltd. was used.

Regarding three positions: a center position in a longitudinal direction of the charging roller, and positions 90 mm away from the center position to the left and right, the charging roller was rotated by 1° each time, and the positions corresponding to the set portion and the non-set portion were measured. Next, a difference between a maximum value of the radius of the non-set portion and a minimum value of the radius of the set portion was calculated. A value at which the difference in radius was largest of the three portions was defined as a set amount in the present invention. Table 8 shows the results.

With the charging roller according to this example, a set image was not generated, and a satisfactory image was obtained.

### Examples 2 to 18

### Charging Rollers 2 to 18

Charging rollers 2 to 18 were produced in the same way as in Example 1 with the exception that the kind and number of parts of added particles were changed as shown in Table 8. Table 8 shows the results.

### Example 19

### Charging Roller 19

A charging roller 19 was produced in the same way as in Example 1 with the exception that the conductive rubber composition 1 was changed to the conductive rubber composition 2 produced in Production Example 37. Table 8 shows the results.

### Examples 20 to 22

### Charging Rollers 20 to 22

Charging rollers 20 to 22 were produced in the same way as in Example 19 with the exception that the kind and number of parts of added particles were changed as shown in Table 8. Table 8 shows the results.

### Example 23

### Charging Roller 23

A charging roller 23 was produced in the same way as in Example 1 with the exception that the kind and number of parts of added particles were changed as shown in Table 8. Table 8 shows the results.

### Examples 24 to 26

### Charging Rollers 24 to 26

Charging rollers 24 to 26 were produced in the same way as in Example 19 with the exception that the kind and number of parts of added particles were changed as shown in Table 8. Table 8 shows the results.

### Example 27

### Charging Roller 27

A charging roller 27 was produced in the same way as in Example 19 with the exception that the conductive resin coating liquid was not applied in Example 19. Table 8 shows the results.

### Examples 28 to 32

### Charging Rollers 28 to 32

Charging rollers 28 to 32 were produced in the same way as in Example 1 with the exception that the kind and number of parts of added particles were changed as shown in Table 8. Table 8 shows the results.

### Example 33

### Charging Roller 33

A charging roller 33 was produced in the same way as in Example 19 with the exception that the kind and number of parts of added particles were changed as shown in Table 8. Table 8 shows the results.

### Example 34

### Electro-Conductive Substrate

A stainless-steel substrate having a diameter of 6 mm and a length of 252.5 mm was coated with a thermosetting adhesive containing 10% by mass of carbon black and dried to be used as an electro-conductive substrate.

(Formation of Elastic Layer)

An electro-conductive substrate was coated with the same conductive rubber composition as the conductive rubber composition 1 produced in Production Example 36 with the exception that the particles were changed to the particles 28 and the number of parts of added particles was changed to 15 parts by mass in a cylindrical shape coaxially with the electro-conductive substrate being a center axis, through use of an extruder provided with a crosshead illustrated in FIG. 8 to produce a preform. The thickness of the rubber composition used for the coating was adjusted to 3 mm.

An elastic roller 34 having an elastic layer with an outer diameter (φ) of 12 mm and a length of 224.2 mm was obtained by the same method as that of the elastic roller 1 in Example 1.

(Production of Charging Roller 34)

The conductive resin coating liquid 1 produced in Production Example 42 was applied onto the elastic roller 34 thus produced once by dipping by the same method as that of the charging roller 1 in Example 1 to obtain a charging roller 34. The obtained charging roller 34 was measured for its electrical resistance and shape and evaluated for its image in the same way as in Example 1. Table 8 shows the results.

### Examples 35 to 38

Charging rollers 35 to 38 were produced by the same method as in Example 34 with the exception that the kind and number of parts of added particles were changed as shown in Table 8. Table 8 shows the results.

### Example 39

A charging roller 39 was produced by the same method as in Example 34 with the exception that the conductive rubber composition 1 was changed to the conductive rubber composition 2 produced in Production Example 37, and the kind and number of parts of added particles were changed as shown in Table 8. Table 8 shows the results.

### Comparative Example 1

A charging roller 40 was produced by the same method as that of Example 1 with the exception that the conductive rubber composition 1 was changed to the conductive rubber composition 3 produced in Production Example 38, and the kind and number of parts of added particles were changed as shown in Table 8 in Example 1. Table 8 shows the results.

### Comparative Example 2

A charging roller 41 was produced by the same method as that of Example 1 with the exception that the conductive rubber composition 1 was changed to the conductive rubber composition 4 produced in Production Example 39, and the kind and number of parts of added particles were changed as shown in Table 9 in Example 1. Table 8 shows the results.

### Comparative Example 3

A charging roller 42 was produced by the same method as that of Comparative Example 2 with the exception that the particles 33 were changed to the particles 34, and the kind and number of parts of added particles were changed as shown in Table 8 in Comparative Example 2. Table 8 shows the results.

### Comparative Example 4

A charging roller 43 was produced by the same method as that of Comparative Example 2 with the exception that the particles 33 were changed to the particles 35, and the ADCA was not added in Comparative Example 2. Table 8 shows the results.

TABLE 8

| | | | | Amount of | Roller | Particle | Cell | | | |
|---|---|---|---|---|---|---|---|---|---|---|
| | | Charging | Particle | added particles | resistance | diameter D1 | diameter D2 | | | Set amount |
| | | roller No. | No. | (parts by mass) | (Ω) | (μm) | (μm) | (D1/D2)³ | Set image | (μm) |
| Example | 1 | 1 | 1 | 10 | 2.0 × 10⁵ | 30 | 40 | 0.42 | 1 | 9 |
| | 2 | 2 | 1 | 15 | 1.6 × 10⁶ | 30 | 43 | 0.34 | 1 | 10 |
| | 3 | 3 | 1 | 20 | 1.2 × 10⁵ | 30 | 46 | 0.28 | 1 | 9 |
| | 4 | 4 | 2 | 15 | 1.1 × 10⁵ | 30 | 50 | 0.22 | 2 | 11 |
| | 5 | 5 | 3 | 12 | 2.6 × 10⁵ | 45 | 50 | 0.73 | 1 | 10 |
| | 6 | 6 | 4 | 15 | 1.2 × 10⁵ | 15 | 50 | 0.03 | 3 | 13 |
| | 7 | 7 | 5 | 15 | 1.2 × 10⁵ | 48 | 50 | 0.88 | 3 | 13 |
| | 8 | 8 | 6 | 15 | 2.8 × 10⁵ | 60 | 95 | 0.25 | 2 | 12 |
| | 9 | 9 | 7 | 15 | 1.1 × 10⁵ | 80 | 110 | 0.38 | 1 | 9 |
| | 10 | 10 | 8 | 15 | 2.7 × 10⁵ | 65 | 90 | 0.38 | 1 | 9 |
| | 11 | 11 | 9 | 15 | 1.4 × 10⁵ | 90 | 102 | 0.69 | 1 | 10 |
| | 12 | 12 | 10 | 15 | 1.3 × 10⁵ | 30 | 70 | 0.08 | 3 | 13 |
| | 13 | 13 | 11 | 15 | 9.7 × 10⁴ | 94 | 99 | 0.86 | 3 | 12 |
| | 14 | 14 | 12 | 20 | 1.2 × 10⁵ | 15 | 26 | 0.19 | 2 | 11 |
| | 15 | 15 | 13 | 20 | 1.2 × 10⁶ | 25 | 30 | 0.58 | 1 | 10 |
| | 16 | 16 | 14 | 20 | 1.6 × 10⁵ | 27 | 30 | 0.73 | 1 | 10 |
| | 17 | 17 | 15 | 20 | 2.8 × 10⁵ | 10 | 25 | 0.06 | 3 | 12 |
| | 18 | 18 | 16 | 20 | 1.7 × 10⁵ | 27 | 28 | 0.90 | 3 | 13 |
| | 19 | 19 | 1 | 10 | 5.3 × 10⁵ | 30 | 42 | 0.36 | 1 | 9 |
| | 20 | 20 | 17 | 15 | 2.1 × 10⁵ | 60 | 70 | 0.63 | 1 | 9 |
| | 21 | 21 | 18 | 15 | 1.1 × 10⁵ | 15 | 45 | 0.04 | 3 | 13 |
| | 22 | 22 | 19 | 15 | 2.9 × 10⁵ | 48 | 51 | 0.83 | 3 | 12 |
| | 23 | 23 | 17 | 15 | 7.6 × 10⁵ | 60 | 69 | 0.66 | 1 | 9 |
| | 24 | 24 | 20 | 15 | 2.4 × 10⁵ | 30 | 44 | 0.32 | 1 | 9 |
| | 25 | 25 | 21 | 15 | 2.3 × 10⁵ | 20 | 44 | 0.09 | 3 | 12 |
| | 26 | 26 | 22 | 15 | 9.9 × 10⁴ | 50 | 52 | 0.89 | 3 | 13 |
| | 27 | 27 | 1 | 10 | 1.8 × 10⁶ | 30 | 40 | 0.42 | 1 | 10 |
| | 28 | 28 | 23 | 15 | 3.5 × 10⁵ | 25 | 46 | 0.16 | 2 | 10 |
| | 29 | 29 | 24 | 15 | 1.2 × 10⁵ | 40 | 53 | 0.43 | 1 | 9 |
| | 30 | 30 | 25 | 15 | 1.1 × 10⁵ | 45 | 51 | 0.69 | 1 | 10 |
| | 31 | 31 | 26 | 15 | 3.7 × 10⁵ | 15 | 51 | 0.03 | 3 | 13 |
| | 32 | 32 | 27 | 15 | 2.6 × 10⁵ | 48 | 51 | 0.83 | 3 | 13 |
| | 33 | 33 | 24 | 15 | 4.5 × 10⁵ | 40 | 52 | 0.46 | 1 | 9 |
| | 34 | 34 | 28 | 15 | 3.7 × 10⁵ | 25 | 52 | 0.11 | 2 | 11 |
| | 35 | 35 | 29 | 15 | 1.7 × 10⁶ | 40 | 50 | 0.51 | 1 | 10 |
| | 36 | 36 | 30 | 15 | 1.7 × 10⁶ | 45 | 49 | 0.77 | 1 | 9 |
| | 37 | 37 | 31 | 15 | 1.8 × 10⁶ | 15 | 50 | 0.03 | 3 | 12 |
| | 38 | 38 | 32 | 15 | 7.6 × 10⁵ | 48 | 50 | 0.88 | 3 | 13 |
| | 39 | 39 | 29 | 15 | 1.7 × 10⁶ | 40 | 51 | 0.48 | 1 | 10 |
| Comparative | 1 | 40 | — | — | 2.2 × 10⁶ | — | 53 | — | 4 | 16 |
| example | 2 | 41 | 33 | 15 | 2.6 × 10⁶ | — | 48 | — | 4 | 15 |
| | 3 | 42 | 34 | 15 | 9.3 × 10⁵ | — | 46 | — | 4 | 15 |
| | 4 | 43 | 35 | 15 | 1.2 × 10⁵ | — | 51 | — | 4 | 16 |

(Production and Evaluation of Developing Roller)

### Example 40

### Electro-Conductive Substrate

A stainless-steel substrate having a diameter of 6 mm and a length of 240 mm was coated with a thermosetting adhesive containing 10% by mass of carbon black and dried to be used as an electro-conductive substrate.

(Formation of Elastic Layer)

An electro-conductive substrate was coated with the conductive rubber composition 1 produced in Production Example 36 in a cylindrical shape coaxially with the electro-conductive substrate being a center axis, through use of an extruder provided with a crosshead illustrated in FIG. 8 to produce a preform. The thickness of the coated rubber composition was adjusted to 1.75 mm. An elastic roller 40 having an elastic layer with an outer diameter (φ) of 12 mm and a length of 232 mm was obtained by the same method as that of the elastic roller 1 in Example 1.

(Production of Developing Roller 1)

The conductive resin coating liquid 2 produced in Production Example 43 was once applied onto the elastic roller 40 thus produced by dipping by the same method as that of the charging roller 1 in Example 1 to obtain a developing roller 1.

(Measurement of Electrical Resistance of Developing Roller)

The resistance of the developing roller was measured with an instrument for measuring an electrical resistance illustrated in FIG. 5.

First, the developing roller was brought into abutment with a columnar metal 32 (having a diameter of 50 mm) by bearings 33a and 33b so that the developing roller was parallel to the metal.

In this case, the abutment pressure was adjusted to 4.9 N at one end, i.e., a total of 9.8 N at both ends with a spring pressure.

Next, the developing roller was rotated with a motor (not shown) following the columnar metal 32 rotationally driven at a circumferential speed of 50 mm/sec.

During the rotation following the metal, a DC voltage of +50 V was applied from a stabilized power supply 34, and then a value for a current flowing through the developing roller was measured with an ammeter 35. The resistance of the developing roller 1 was calculated from the applied voltage and the current value. The developing roller 1 was left to stand still in an environment of a temperature of 23° C. and a humidity of 50% RH for 24 hours or more before its electrical resistance was measured. As a result, the electrical resistance of the developing roller 1 was 1.0×10⁵Ω.

(Shape Measurement of Elastic Layer Cross-Section)

The shape measurement of the elastic layer was performed by the same method as that of Example 1.

(Evaluation of Horizontal Line Image Due to Set)

As an electrophotographic apparatus having a configuration illustrated in FIG. 6, a color laser printer LBP5400 (trade name) manufactured by Canon Inc. was remodeled so as to have an output speed of a recording medium of 200 mm/sec (A4 vertical output) to be used. The image resolution was 600 dpi, and the output of primary charging was a DC voltage of −1,100 V.

As a process cartridge having a configuration illustrated in FIG. 7, a process cartridge (for black) for the printer was used.

An accompanying charging roller was taken out from the above-mentioned process cartridge, and the charging roller according to the present invention was set in an abutment state.

The process cartridge was left to stand still for 1 month in an environment of a temperature of 40° C. and a humidity of 95% RH (left to stand under harsh conditions). Then, the process cartridge was left to stand still for 6 hours in an environment of a temperature of 23° C. and a humidity of 50% RH, and then mounted on the above-mentioned electrophotographic apparatus, and an image was output in the same environment. As an evaluation image, a half-tone image (image drawing horizontal lines at a width of one dot in a direction perpendicular to the rotation direction of the photosensitive member at an interval of two dots) was output. The output image was evaluated for its set image based on the criteria described in the Table 9 below. Table 10 shows the evaluation results.

TABLE 9

| | |
|---|---|
| Rank 1 | No set image is generated. |
| Rank 2 | Only a slight stripe-like image is recognized. |
| Rank 3 | Although a stripe-like image is partly recognized |
| | at a pitch of the charging roller, image quality |
| | has no practical problem. |
| Rank 4 | A stripe-like image is conspicuous, and degradation |
| | in image quality is recognized. |

(Measurement of Set Amount)

A set amount was measured by the same method as that of Example 1.

With the developing roller 1 according to this example, a set image was not generated, and a satisfactory image was obtained.

### Examples 41 to 44

Developing rollers 2 to 5 were produced by the same method as that of Example 40 with the exception that the kind and number of parts of added particles were changed as shown in Table 10. Table 10 shows the results.

### Comparative Example 5

A developing roller 6 was produced by the same method as that of Example 1 with the exception that the conductive rubber composition 1 was changed to the conductive rubber composition 3 produced in Production Example 38, and the kind and number of parts of added particles were changed as shown in Table 10 in Example 40. Table 10 shows the results.

### Comparative Example 6

A developing roller 7 was produced by the same method as that of Example 1 with the exception that the conductive rubber composition 1 was changed to the conductive rubber composition 4 produced in Production Example 39, and the kind and number of parts of added particles were changed as shown in Table 10 in Example 40. Table 10 shows the results.

TABLE 10

| | | | | Amount of | | | | | | |
|---|---|---|---|---|---|---|---|---|---|---|
| | | | | added | | | | | | |
| | | | | particles | Roller | Particle | Cell diameter | | Evaluation | Set |
| | | Developing | | (parts by | resistance | diameter D1 | D2 | | of Set | amount |
| | | roller No. | Particle No. | mass) | (Ω) | (μm) | (μm) | (D1/D2)³ | image | (μm) |
| Example | 40 | 1 | 1 | 10 | 1.0 × 10⁵ | 30 | 41 | 0.39 | 1 | 10 |
| | 41 | 2 | 2 | 15 | 2.1 × 10⁵ | 30 | 48 | 0.24 | 2 | 11 |
| | 42 | 3 | 3 | 12 | 1.6 × 10⁵ | 45 | 51 | 0.69 | 1 | 10 |
| | 43 | 4 | 4 | 15 | 5.2 × 10⁵ | 15 | 50 | 0.03 | 3 | 13 |
| | 44 | 5 | 5 | 15 | 4.7 × 10⁵ | 48 | 51 | 0.83 | 3 | 13 |
| Comparative | 5 | 6 | — | — | 3.8 × 10⁶ | — | 51 | — | 4 | 16 |
| Example | 6 | 7 | 33 | 15 | 2.3 × 10⁶ | — | 46 | — | 4 | 15 |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims priority from Japanese Patent Application No. 2011-267222 filed on Dec. 6, 2011, the content of which is hereby incorporated by reference.

What is claimed is:

1. An electro-conductive member, comprising:
an electro-conductive substrate; and
a porous rubber elastic layer,
wherein:
the porous rubber elastic layer includes a closed cell including a particle; and
the particle is not fixed to an inner wall of the closed cell.

2. The electro-conductive member according to claim 1, wherein a volume average particle diameter D1 of the particle and a volume average diameter D2 of the closed cell satisfy a relationship of 0.1(D1/D2) 0.8.

3. The electro-conductive member according to claim 2, wherein the D2 is 20 μm or more and 200 μm or less.

4. The electro-conductive member according to claim 1, wherein the particle includes an acrylic resin or a silicone resin.

5. The electro-conductive member according to claim 1, wherein the electro-conductive member has a roller shape.

6. A process cartridge, comprising:
the electro-conductive member according to claim 1; and
a body to be charged, which is integrated with the electro-conductive member,
the process cartridge being attachable to and detachable from a main body of an electrophotographic apparatus.

7. An electrophotographic apparatus, comprising:
the electro-conductive member according to claim 1; and
a body to be charged.
